(19) United States
(12) Patent Application Publication
(10) Pub. No.: US 2006/0265961 A1
(43) Pub. Date: Nov. 30, 2006

(54) Automobile door assemblies

(76) Inventors: Jay Winborn, Berkley, MI (US); Keith Ruedisueli, Rochester Hills, MI (US)

Correspondence Address: BUTZEL LONG, 350 SOUTH MAIN STREET, SUITE 300, ANN ARBOR, MI, 48104, US

(21) Appl. No.: 11/134,942

(22) Filed: May 23, 2005

(51) Int. Cl. B60J 5/04

(52) U.S. Cl. 49/502

(57) ABSTRACT

Improved barrier liner panels for a motor vehicle door assembly that either include a non-adhesive sealing element integrally formed therewith or engaging structures that engage the peripheral edge of an opening formed in a door panel. The integrally formed sealing element is compressible so as to seal against a door panel when pressed between an inner trim panel and a door panel. The engaging structure cooperate with beads of adhesive to hold the barrier lines to a door panel during the assembly of a door assembly and to form a seal against the door panels.

### TECHNICAL FIELD

The present invention relates to vehicle door water shield barriers which prevent the ingress of water, sound, dust and air into a vehicle passenger compartment. More particularly, according to one embodiment, the present invention relates to water seal or barrier panels for vehicle door assemblies that include integrated sealing elements and avoid the use of adhesives or adhesive beads. According to another embodiment, the present invention relates to water seal or barrier panels for vehicle door assemblies which include engagement structures that are configured to align and secure the water seal or barrier panels directly to door panels.

### BACKGROUND ART

Automobile door assemblies generally include a door panel to which an inner trim panel is joined. The door panel includes a cavity within which the door window may be lowered. This cavity may also contain window regulating equipment, door locks, sound speakers, air bag systems, and the like. The inner trim panel is typically a rigid or semi-rigid panel formed of a cloth-like or plastic trim material which serves as the interior passenger compartment panel.

Door assemblies are susceptible to the ingress of water which can enter into door cavities through the openings through which the door windows slide. Holes are generally formed in the bottom of door assemblies to allow any water that enters the door cavities to drain out. However, as water enters door cavities and runs down toward the drain holes, it can seep into and through the inner trim panels unless a barrier of some type is provided in the assembly.

In order to protect inner trim panels from becoming wet and possibly stained or otherwise damaged, it is common to attach panel liners over door panels beneath inner trim panels. Such panel liners are often made of a treated paper material or can comprise a thin plastic film. The panel liners function to deflect any water entering door cavities so that the water runs down the liners to the bottoms of the door cavities without contacting the inner trim panels.

Liners used in door assemblies are typically sealed to the door panels of door assemblies by an adhesive which is provided as a bead that extends along the periphery of the liners. In order to protect the adhesive bead, a release sheet is secured to the liners over the adhesive bead. The release sheet has to be removed when a liner is applied to a door panel of a door assembly.

In general, the use of adhesives involves some disadvantages. For example, adhesive beads on liners loose their ability to reseal over time when they are removed and reinstalled as for instance when a door assembly has to be disassembled for repair. In addition, adhesives or adhesive beads which can degrade over time.

According to one embodiment, the present invention provides water seal or barrier panels for vehicle door assemblies that include integrated sealing elements and avoid the use of adhesives or adhesive beads.

Inner trim panels of door assemblies are typically attached to door panels by a plurality of push-in fasteners that are commonly referred to as “Christmas trees.” The push-in fasteners extend outward from the outboard side of the inner trim panels and are spaced apart adjacent the peripheral edge of the inner trim panels. The inboard surface of the door panels include through-holes which are aligned to receive the push-in fasteners provided on the inner trim panels. The inner trim panels are attached to the door panels by aligning and pushing the push-in fasteners on the inner trim panels into the through-holes in the door panels.

When assembling door assemblies liners are often attached to the inner trim panels by the plurality of push-in fasteners with the outboard side of the water seal or barrier panels having the adhesive bead facing the door panels. The push-in fasteners hold and align the liners in position until the push-in fasteners are received in the through-holes in the door panels. Since it typically requires more push-in fasteners to secure an inner trim panel to a door panel than is necessary to hold the water seal or barrier panels in position, it is common in door assemblies to have tolerance variances between the inner trim panel and door panels.

According to another embodiment, the present invention provides for water seal or barrier panels that are configured and designed to attach directly to door panels and thereby avoid having to hold the water seal or barrier panels to the outboard surface of inner trim panels during the assembly of a door assembly.

### DISCLOSURE OF THE INVENTION

According to various features, characteristics and embodiments of the present invention which will become apparent as the description thereof proceeds, the present invention provides a barrier liner for a vehicle door assembly having a door panel and an inner trim panel, the barrier liner including:

a sheet of substantially water-impermeable material that is substantially complimentarily shaped to the door panel; and

a sealing element that extends adjacent a peripheral portion of the sheet of substantially water-impermeable material and is integrally formed with the sheet of substantially water-impermeable material.

The present invention further provides a barrier liner for a vehicle door assembly which include:

a sheet of substantially water-impermeable material that is substantially complimentarily shaped to the door panel having an inboard surface and an outboard surface; and

a plurality of engaging structures that extend outward from the outboard surface of the sheet of substantially water-impermeable material and which are configured to engage a peripheral edge of an opening formed in an inboard surface of a door panel.

The present invention further provides for door assemblies that include the different barrier liners.

The present invention also provide a method of assembling a door assembly which comprises:

providing a door panel having at least one opening formed in an inboard surface thereof;

providing an inner trim panel;

providing a barrier liner having a plurality of engaging structures that extend outward from an outboard surface of the barrier liner;

attaching the barrier liner to the inboard surface of the door panel by engaging the engaging structures of the barrier liner with a peripheral edge of the at least one opening formed in the inboard surface of the door panel; and

attaching the inner trim panel to the door panel over the barrier liner.

### BRIEF DESCRIPTION OF DRAWINGS

The present invention will be described with reference to the attached drawings which are given as non-limiting examples only, in which:

FIG. 1 is an exploded perspective view of a motor vehicle door assembly that includes a water seal or barrier panel according to the present invention.

FIG. 2 is an elevational view of a water seal or barrier panel according to one embodiment of the present invention.

FIG. 3A is an elevational view of a water seal or barrier panel according to one embodiment of the present invention.

FIG. 3B is a sectional view of the sealing element taken along section line III-III in FIG. 3A.

FIG. 4A is an elevational view of a water seal or barrier panel according to one embodiment of the present invention.

FIG. 4B is a sectional view of the sealing element taken along section line IV-IV in FIG. 4A.

FIG. 5A is an elevational view of a water seal or barrier panel according to one embodiment of the present invention.

FIG. 5B is a sectional view of the sealing element taken along section line V-V in FIG. 5A.

FIG. 6A is an elevational view of a water seal or barrier panel according to one embodiment of the present invention.

FIG. 6B is a sectional view of the sealing element taken along section line VI-VI in FIG. 6A.

FIG. 7A is an elevational view of a water seal or barrier panel according to one embodiment of the present invention.

FIG. 7B is a sectional view of the sealing element taken along section line VII-VII in FIG. 7A.

FIG. 8A is an elevational view of a water seal or barrier panel according to one embodiment of the present invention.

FIG. 8B is a sectional view of the sealing element taken along section line VIII-VIII in FIG. 8A.

FIG. 9A is an elevational view of a water seal or barrier panel according to one embodiment of the present invention.

FIG. 9B is a sectional view of the sealing element taken along section line IX-IX in FIG. 9A.

FIG. 10 is an exploded perspective view of a motor vehicle door assembly that includes a water seal or barrier panel according to another embodiment of the present invention.

FIG. 11A is an elevational view of a door assembly showing a water seal or barrier panel according to one embodiment of the present invention in phantom.

FIG. 11B is a sectional view of the door assembly of FIG. 11A taken along section lines XI-XI.

FIG. 11C is an enlarged view of the encircled portion of the door assembly illustrated in FIG. 11B.

FIG. 12 is an exploded perspective view of a motor vehicle door assembly that includes a water seal or barrier panel according to another embodiment of the present invention.

FIG. 13A is an elevational view of a door assembly showing a water seal or barrier panel according to one embodiment of the present invention in phantom.

FIG. 13B is a sectional view of the door assembly of FIG. 13A taken along section lines XII-XII.

FIG. 13C is an enlarged view of the encircled portion of the door assembly illustrated in FIG. 13B.

### BEST MODEM FOR CARRYING OUT THE INVENTION

According to one embodiment, the present invention is directed to water seal or barrier panels for vehicle door assemblies that include integrated sealing elements and avoid the use of adhesives or adhesive beads. The water seal or barrier panels of the present invention are configured to be received between an inner trim panel and a door panel of a door assembly and to provide a peripheral seal against the door panels. The water seal or barrier panels include a sheet of material that has a configuration to be is complementary shaped to the inner or inboard surface of a door panel at least around the periphery thereof and a sealing element that extends along the peripheral edge of the water seal or barrier panels.

The sealing element can be made from the same material as the water seal or barrier panel and be integrally formed, e.g. molded therewith to provide a unitary structure. Alternatively, the sealing element can be formed from a material that is different or has a different physical property, e.g., density, compressibility, etc. from the water seal or barrier panel and co-molded thereon or separately attached along the peripheral edge of the water seal or barrier panel. Suitable materials from which the water seal or barrier panel and sealing element can be molding include polyolefin foams, including cross-linked polyethylene or polypropylene foam or any similar material that is compressible and will function as a moisture barrier.

The sealing elements are suitable compressible so that when they are compressed between an inner trim panel and a door panel, they form a seal against the door panel which prevents water that enters the door cavity from contacting and wetting the inner trim panel. The desired compressibility of the seal elements can be obtained by either making the sealing elements from a soft compressible material and/or by making the sealing elements hollow or convex and configured so as to present a sealing surface that presses against the inner trim panel when the water seal or barrier panels are compressed between the inner trim panel and a door panel. As will be discussed in more detail below, the sealing elements can have a variety of cross-sectional shapes. The sealing elements are generally positioned along or adjacent at least a portion of the peripheral edge of the water seal or barrier panel so as to provide a continuous seal or barrier that prevents water ingress. The sealing elements can either complementary follow the periphery of the water seal or barrier panel or can have an independent serpentine or sinusoidal shape. Although one function of the water seal or barrier panels of the present invention is to prevent water from wetting and damaging interior trim panels, reference to “barrier” panels in addition to water seal panels is made because the panels also provide a barrier against dirt, dust, air and noise from transgressing through a car door assembly.

The sealing elements of the present invention can be compressed into sealing contact with the door panel by the use of any type of conventional mechanical fasteners that are used to secure the inner trim panel to the door panel, such as screws, clips, push-in fasteners, etc.

The use of a non-adhesive sealing means and avoidance of adhesives or adhesive beads eliminates the use of release sheets which are typically used to protect adhesives or adhesive beads on conventional water seal barrier liners. In addition, the use of a compressible sealing element that does not include an adhesive allows the water seal or barrier panels of the present invention to be removed and reinstalled without loss of the panel's sealing capability Features and characteristics of the present invention will be hereafter described with reference to the attached drawings which are provided as non-limiting examples only. Throughout the drawings, similar reference numerals are used to identify common elements when possible in order to simplify the description.

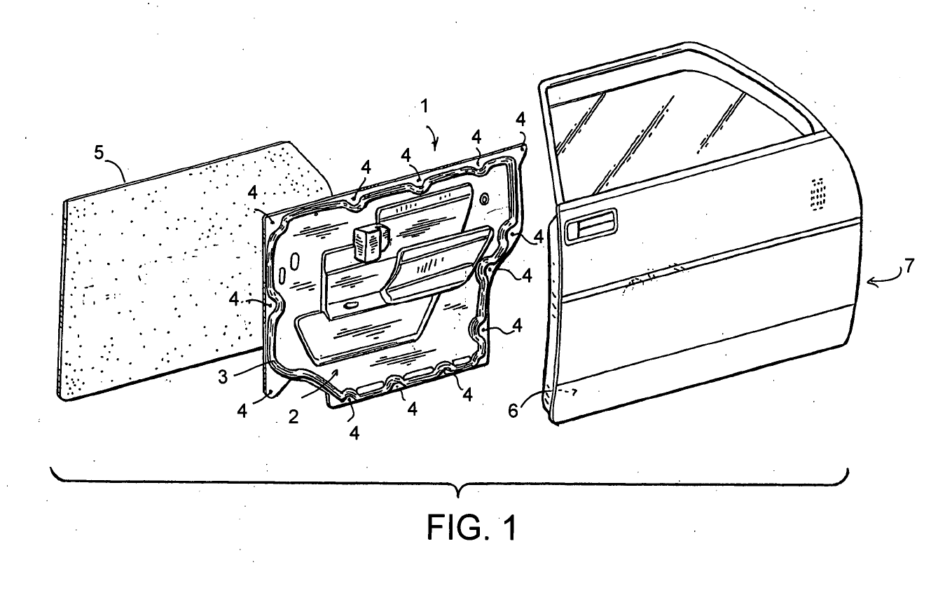

FIG. 1 is an exploded perspective view of a motor vehicle door including a water seal or barrier panel according to the present invention. The water seal or barrier panel 1 includes a generally planer sheet 2 that has been molded in the center so as to conform to, receive or accommodate various components of a vehicle door such as a door latching handle, window control mechanism, power seat control panel, etc. (none shown). A sealing element 3 is disposed near the periphery of the water seal or barrier panel 1. The water seal or barrier panel 1 includes a plurality of though-holes 4 along the periphery thereof through which suitable fasteners (not shown) such as panel insert fasteners provided in the inner trim panel 5 can be used to secure the water seal or barrier panel 1 to the door panel 6 of the vehicle door 7. The inner trim panel 5 distributes force that is applied at each point where the fasteners attach the inner trim panel 5 to the door panel 6 thereby pressing the sealing element 3 against the door panel 6 throughout the length of the sealing element 3. Although not shown in FIG. 1, it is possible in some door assembly designs to use water seal or barrier panels that have cut-out portions or areas that can be sealed by providing a separate sealing element around such cut-out portions or areas.

The water seal or barrier panel 1 can be made from a polyolefin foam, for example a cross-linked polyethylene or polypropylene foam or any similar material that is compressible and will function as a moisture barrier. The water seal or barrier panel 1 can have a thickness of from about_to about_and preferably from about_to about_.

The inner trim panel 5 can be made from a relatively rigid material such as hard plastic, or a covered plastic or covered cellulose based material or composite thereof. The covering can be fabric, vinyl, cloth, thermoplastic olefins (TPO), leather, carpet or any combination thereof.

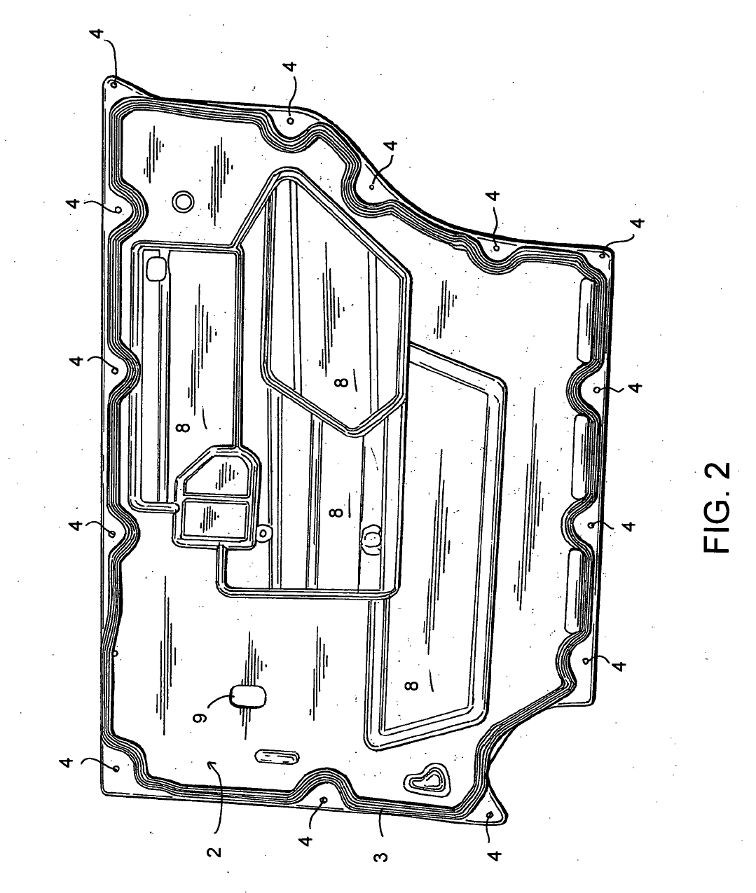

FIG. 2 is an elevational view of a water seal or barrier panel according to one embodiment of the present invention. The water seal or barrier panel 1 includes a generally planer sheet 2 that has been molded in the center so as to have areas 8 that project inwardly into a door assembly that are configured to conform to, receive or accommodate various components of a vehicle door such as a door latching handle, window control mechanism, power seat control panel, etc. (none shown). The location of access panels that may be cut-out can be identified on the water seal or barrier panel 1 and used for access and repair of internal components such as latch and window operating mechanisms. In addition one more through-holes 9 can be provided as necessary to allow devices such as window crank mechanism to extend through the water seal or barrier panel 1.

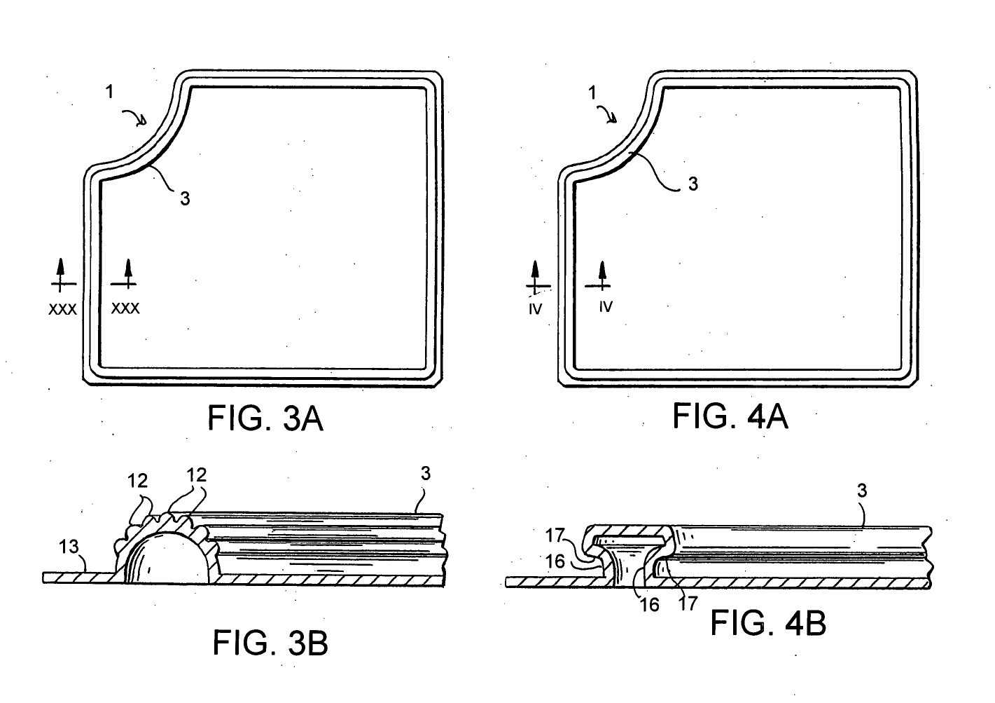

The sealing element 3 is shown as being disposed near the periphery of the water seal or barrier panel 1 and diverting around the plurality of though-holes 4 that are provided and position to receive suitable fasteners (not shown) such as screws, clips, push-in fasteners, panel insert fasteners, etc. provided in the inner trim panel 5 which are used to secure the water seal or barrier panel 1 to the door panel 6 of the vehicle door 7. The sealing element 3 in FIG. 2 is depicted as having a plurality of substantially parallel ridges which will be discussed more in reference to FIG. 3B.

The water seal or barrier panel 1 can have a thickness of from about_to about_with a preferred thickness of about_to about_. The sealing element 3 is preferably molded integrally with the water seal or barrier panel 1 and is therefore made of the same material. Alternatively, the sealing element 3 can be co-molded from a different material or have a different physical property, e.g., density, compressibility, etc. than the remaining portion of the water seal or barrier panel 1. As will be discussed in more detail below, the sealing elements 3 are preferably hollow or convex and configured to present various sealing surface area shapes as they are compressed against the door panel 6. In other embodiments, the sealing elements 3 could be solid rather than hollow or convex. The sealing elements 3 can have a height or thickness of from about_to about_and preferably from about_to about_and a width from about_to about_and preferably from about_to about_.

FIG. 3A is an elevational view of a water seal or barrier panel according to one embodiment of the present invention. The water seal or barrier panel 1 depicted in FIG. 3A does not include the amount of detail that is shown in FIG. 2, because FIG. 3A is provided to illustrate the details of the sealing element 3. It is to be understood that the water seal or barrier panel 1 of FIG. 3A could have the same or similar configuration as that of FIG. 2.

FIG. 3B is a sectional view of the sealing element taken along section line III-III in FIG. 3A. The sealing element 3 in FIGS. 3A and 3B is convex and has a curved or semicircular cross-sectional shape as depicted in FIG. 3B with a plurality of parallel ribs 12 extending along the length of the sealing element 3. As shown in FIG. 3B, the ribs 12 are provided at an upper portion of the sealing element 3 so that there is a gap between the lowermost rib on either side of the sealing element 3 and the upper surface 13 of the water seal or barrier panel 1. This gap, or absence of a rib, will allow the sealing element 3 to flatten under compression so that the ribs 12 will contact and seal against a door panel.

FIG. 4A is an elevational view of a water seal panel according to one embodiment of the present invention. The water seal or barrier panel 1 depicted in FIG. 4A does not include the amount of detail that is shown in FIG. 2, because FIG. 4A is provided to illustrate the details of the sealing element 3. It is to be understood that the water seal or barrier panel 1 of FIG. 4A could have the same or similar configuration as that of FIG. 2.

FIG. 4B is a sectional view of the sealing element taken along section line IV-IV in FIG. 4A. The sealing element 3 in FIGS. 4A and 4B is convex and includes an upper flat central portion 15 that is supported by a pair of opposite curved legs 16. On either side of the flat central portion 15 the sealing element 3 includes slanted over-hanging portions 17. When the sealing element 3 depicted in FIGS. 4A and 4B is pressed against a door panel, the flat central portion 15 will contact and seal against the door panel and the curved legs 16 will fold up under the over-hanging portions 17 so as to apply more force against the flat central portion 15.

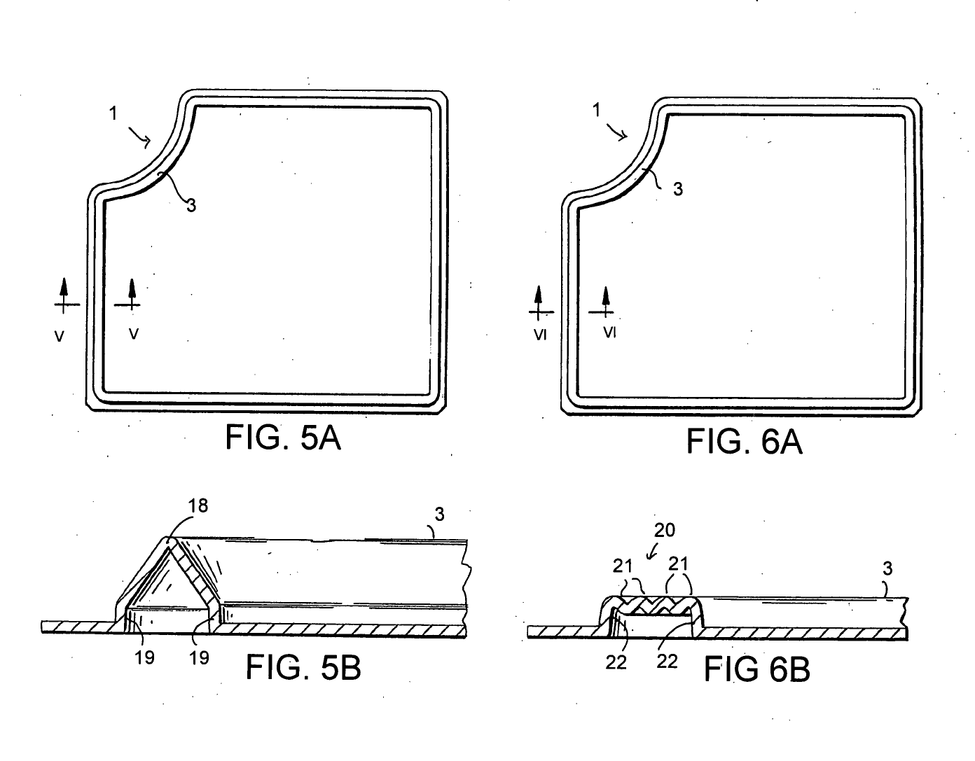

FIG. 5A is an elevational view of a water seal panel according to one embodiment of the present invention. The water seal or barrier panel 1 depicted in FIG. 5A does not include the amount of detail that is shown in FIG. 2, because FIG. 5A is provided to illustrate the details of the sealing element 3. It is to be understood that the water seal or barrier panel 1 of FIG. 5A could have the same or similar configuration as that of FIG. 2.

FIG. 5B is a sectional view of the sealing element taken along section line V-V in FIG. 5A. The sealing element 3 in FIGS. 4A and 4B is convex and has a triangular cross-section with an apex 18 and a pair of opposed legs 19. When the sealing element 3 of FIGS. 5A and 5B is pressed against a door panel, the apex 18 will contact and form a seal against the door panel and the legs 19 will bow outwardly and apply more force against the apex 18 and thereby strengthening the sealing effect against the door panel.

FIG. 6A is an elevational view of a water seal panel according to one embodiment of the present invention. The water seal or barrier panel 1 depicted in FIG. 6A does not include the amount of detail that is shown in FIG. 2, because FIG. 6A is provided to illustrate the details of the sealing element 3. It is to be understood that the water seal or barrier panel 1 of FIG. 6A could have the same or similar configuration as that of FIG. 2.

FIG. 6B is a sectional view of the sealing element taken along section line VI-VI in FIG. 6A. The sealing element of FIGS. 6A and 6B is convex and includes a raised planar portion 20 that includes a number of parallel ridges 21 that extend along the length of the sealing element 3 and a pair of opposed legs 22. When the sealing element 3 of FIGS. 6A and 6B is pressed against a door panel; ridges 21 of the planar portion 20 will contact and seal against the door panel.

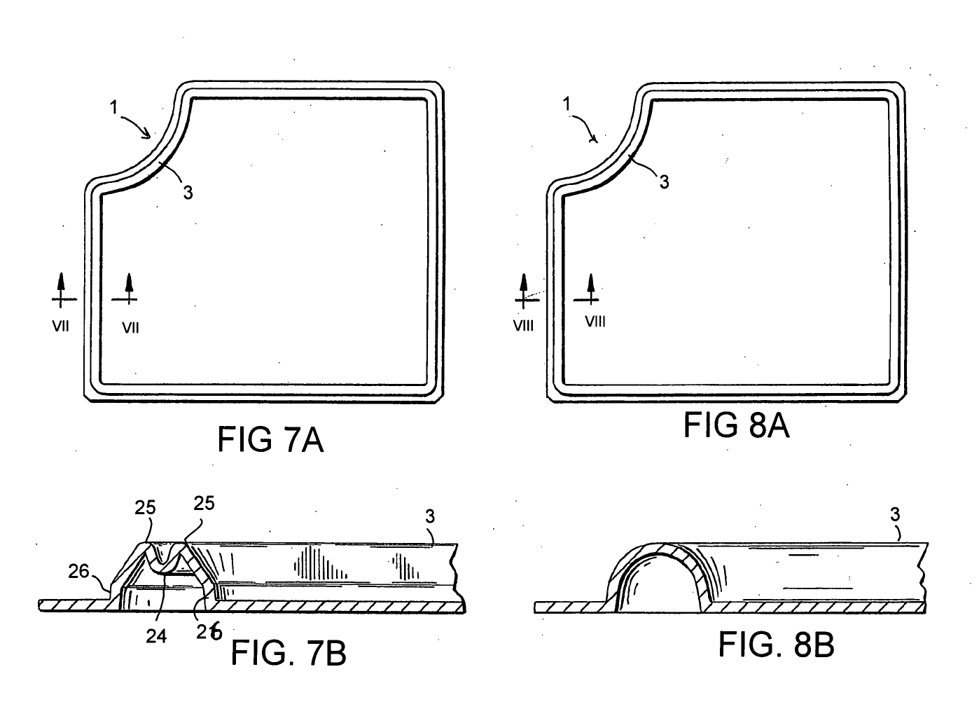

FIG. 7A is an elevational view of a water seal panel according to one embodiment of the present invention. The water seal or barrier panel 1 depicted in FIG. 7A does not include the amount of detail that is shown in FIG. 2, because FIG. 7A is provided to illustrate the details of the sealing element 3. It is to be understood that the water seal or barrier panel 1 of FIG. 7A could have the same or similar configuration as that of FIG. 2.

FIG. 7B is a sectional view of the sealing element taken along section line VII-VII in FIG. 7A. The sealing element 3 in FIGS. 7A and 7B is convex and has a triangular cross-section with an inverted apex 24 that forms a pair of protrusions 25 and has a pair of opposed legs 26 that extend from the surface 27 of the water seal or barrier panel 1. When the sealing element 3 of FIGS. 7A and 7B is pressed against a door panel, the pair of protrusions 25 on either side of the inverted apex 24 will contact and form a seal against the door panel and the legs 26 will bow outwardly and apply more force against the pair of protrusions 25 thereby strengthening the sealing effect against the door panel.

FIG. 8A is an elevational view of a water seal panel according to one embodiment of the present invention. The water seal or barrier panel 1 depicted in FIG. 8A does not include the amount of detail that is shown in FIG. 2, because FIG. 8A is provided to illustrate the details of the sealing element 3. It is to be understood that the water seal or barrier panel 1 of FIG. 8A could have the same or similar configuration as that of FIG. 2.

FIG. 8B is a sectional view of the sealing element taken along section line VIII-VIII in FIG. 8A. The sealing element 3 in FIGS. 8A and 8B is convex and has a curved or semicircular cross-sectional shape as depicted in FIG. 8B. When the sealing element of FIGS. 8A and 8B is pressed against a door panel, the leaning edge of the curved or semicircular portion will contact and seal against the door panel.

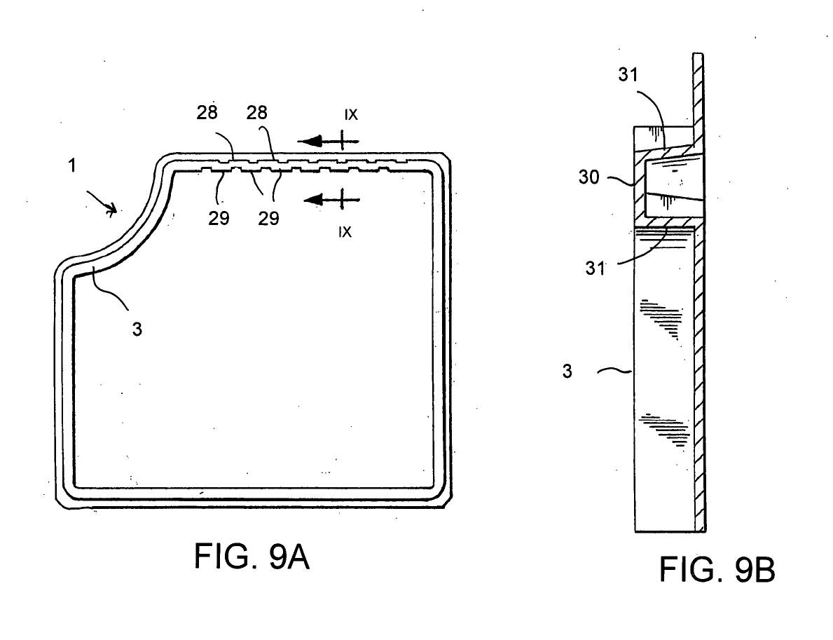

FIG. 9A is an elevational view of a water seal panel according to one embodiment of the present invention. The water seal or barrier panel 1 depicted in FIG. 9A does not include the amount of detail that is shown in FIG. 2, because FIG. 9A is provided to illustrate the details of the sealing element 3. It is to be understood that the water seal or barrier panel of FIG. 9A could have the same or similar configuration as that of FIG. 2. In FIG. 9A a portion or length of the sealing element 3 has a non-linear shape which includes alternating stepped portions 28 and 29. In alternative embodiments, the non-linear shaped portion of the sealing element could be serpentine or sinusoidal shaped, or zigzag shaped, or have other non-linear shape. In addition a portion, portions or the entire sealing element 3 could have a non-linear shape.

FIG. 9B is a sectional view of the sealing element taken along section line IX-IX in FIG. 9A. As shown in FIG. 9B the sealing element 3 of FIG. 9A has a raised substantially flat surface 30 and a pair of legs 31 that extend from the substantially flat surface 30 to the surface 31 of the water seal or barrier panel 1.

It is to be understood that the water seal or barrier panels of the present invention can combined any of the various illustrated sealing elements in any desired manner, including using different cross-sectional configurations along different portions of sealing element on the same water seal or barrier panel and using sealing elements that have different cross-sectional configurations in either linear, or non-linear patterns on the water seal or barrier panel. Moreover, as indicated above, the various illustrated sealing elements are only non-limiting examples of cross-sectional and non-linear shapes that can be used for the sealing elements of the present invention.

According to another embodiment, the present invention provides water seal or barrier panels for vehicle door assemblies which include engagement structures that are configured to align and secure the water seal or barrier panels directly to door panels. This embodiment of the present invention avoids positioning the water seal or barrier panels between the inner trim panels and door panels with mechanical fasteners such as screws, clips, push-in fasteners, etc. extending through each of the inner trim panel, the water seal or barrier panels and the door panels. Moreover, the water seal or barrier panels of this embodiment of the present invention do not have the through-holes 4 that are depicted in the embodiment of the invention depicted in FIG. 1. Accordingly, the water seal or barrier panels of this embodiment are not held to the inner trim panels by mechanical fasteners which the door assemblies are assembled.

In this embodiment of the present invention the outboard surface of the water seal or barrier panels are provided with engaging structures that are configured and aligned to secure the water seal or barrier panels directly to door panels. The engaging structures are preferably molded into the water seal or barrier panels when they are fabricated and can comprise hollow, solid or semi-hollow structures. Alternatively, the engaging structures can be made separately from the water seal or barrier panels and attached or fixed thereto by adhesives, thermal or ultrasonic welding, mechanical fasteners, cooperating engaging structures, etc.

In general the engaging structures are arranged and aligned on the outboard surface of a water seal or barrier panel so that the engaging structures collectively engage a cutout or a plurality of cutouts provided in the inboard surface of a door panel.

The water seal or barrier panels of this embodiment of the present invention are provide with a bead of adhesive around at least a lower portion of the periphery that creates a seal against the inboard surface of a door panel. Then adhesive bead helps hold the water seal or barrier panels against the inboard surface of door panels together with the engaging structures. Moreover, the engaging structures help apply pressure toward the door panels which has the effect of pressing on the bead of adhesive thereby ensuring the production of a good seal thereby.

In this embodiment of the present invention the inner trim panels are secured to the door panels by mechanical fasteners such as screws, clips, push-in fasteners, etc. generally in a conventional manner, but without the mechanical fasteners extending through the water seal or barrier panels. Accordingly, the inner trim panels extend beyond the periphery of the water seal or barrier panels and the through-holes in the door panels which receive the mechanical fasteners of the inner trim panels are spaced outward from the periphery of the water seal or barrier panels.

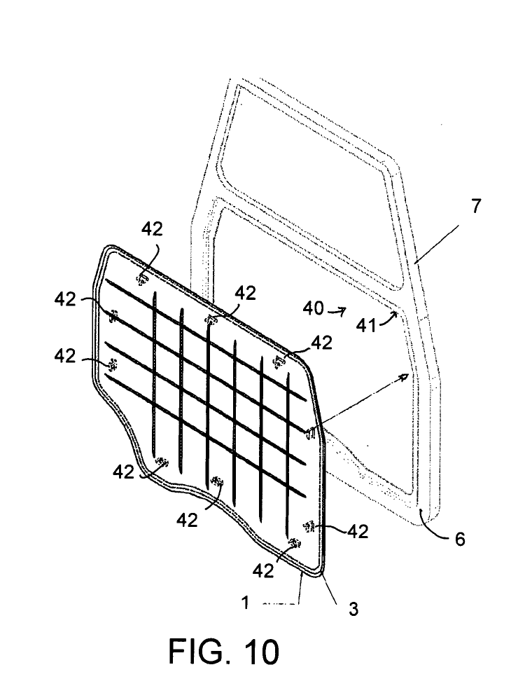

FIG. 10 is an exploded perspective view of a motor vehicle door assembly that includes a water seal or barrier panel according to another embodiment of the present invention. In FIG. 10 the door panel 1 is shown as having an opening 40 formed in the inboard side thereto. The opening 40 has a peripheral edge 41. The water seal or barrier panel 1 shown in FIG. 10 includes a plurality of engaging structures 42 that extend outwards from the outboard side thereof. The engaging structures 42 are spaced apart and aligned so that each will engage a portion of the peripheral edge 41 of the opening 40 formed in the inboard side of the door panel 6. The water seal or barrier panel 1 also includes a bead of adhesive 3 that extends adjacent the periphery thereof on the outboard side. The adhesive bead 3 will contact the inboard side of the door panel 6 when the water seal or barrier panel 1 is moved into contact with the door panel 6 and the engaging structures 42 engage the peripheral edge 41 of opening 40. The engaging structures 42 and adhesive bead 3 both help hold the water seal or barrier panel 1 in place until an inner trim panel (not shown) can be attached to the door panel 6 over the water seal or barrier panel 1. Such an inner trim panel can be attached to the inboard surface of the door panel using conventional fastening means such as screws, clips, push-in fasteners, panel fasteners, etc. As noted above, the trim panel would typically extend beyond the peripheral edges of the water seal or barrier panel 1 and the fastening means would fasten to the door panel 6 beyond the peripheral edges of the water seal or barrier panel 1. It is noted that although the adhesive bead 3 is depicted as extending along the entire periphery of the water seal or barrier panel 1, it is possible to only provide an adhesive bead 3 that extends about a lower portion of the periphery of the water seal or barrier panel 1. Adhesives compositions that are useful of purposes of the present invention are known in the art.

The water seal or barrier panel 1 can be made from a polyolefin foam, for example a cross-linked polyethylene or polypropylene foam or any similar material that is compressible and will function as a moisture barrier. The water seal or barrier panel 1 can have a thickness of from about_to about_and preferably from about_to about_.

The center of water seal or barrier panel 1 shown in FIG. 10 can have any desired shape or configuration desired to conform to, receive or accommodate various components of a vehicle door such as a door latching handle, window control mechanism, power seat control panel, etc. (none shown).

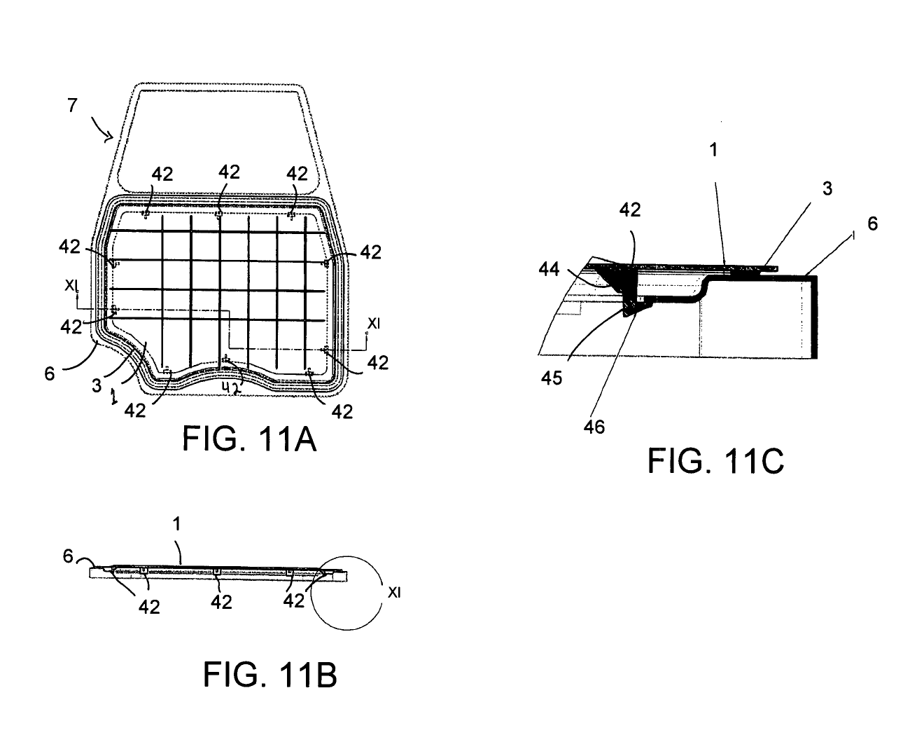

FIG. 11A is an elevational view of a door assembly showing a water seal or barrier panel according to one embodiment of the present invention in phantom. In FIG. 11A the alignment of the engaging structures 42 on the outboard surface of the water seal or barrier panel 1 with respect to the peripheral edge 41 of the opening 40 formed in the inboard surface of the door panel 6 can be seen. As noted above, the engaging structures 42 are spaced apart from one another and aligned so that each will engage a portion of the peripheral edge 41 of the opening 40 formed in the inboard side of the door panel 6. The number of engaging structures 42 and the distance that they are spaced apart can be varied depending on the configuration of the door panel 6 and the shape of opening 40. In some embodiments, instead of one opening 40 two or more openings can be provided in the inboard surface of the door panel 6 and engaging structures 42 can be arranged and aligned to engage peripheral edges of each of the openings. Moreover, one or more of the engaging structures 42 could be configured to be received in a through-hole provided in the inboard surface of the door panel 6. The depiction of the invention in FIG. 11A is intended to show the features of the water seal or barrier panel 1 in reference to the door panel 6. However, it is to be understood that in order to attach an inner trim panel to the assembly depicted in FIG. 11A, the peripheral edge of the door panel 6 would be slightly greater than the peripheral edge of the water seal or barrier panel 1 so as to provide a peripheral area where an inner trim panel could be attached to the door panel 6, over the water seal or barrier panel 1, using conventional fastener means.

FIG. 11B is a sectional view of the door assembly of FIG. 11 taken along section lines XI-XI. In FIG. 11B the manner in which the engaging structures 42 extend outward from the outboard surface of the water seal or barrier panel 1 in order to extend into the opening 40 formed in the inboard surface of the door panel 6 and engage the peripheral edge 41 of the opening 40. FIG. 11C is an enlarged view of the encircled portion of the door assembly illustrated in FIG. 11B. The engaging structure depicted in FIG. 11C is a solid structure that includes a base portion 44 that extends outward from the outboard surface of the water seal or barrier panel 1 and an end portion 45 that forms a catch that engages the edge 41 of opening 40 provided in door panel 6. The base portion 44 that extends outward from the outboard surface of the water seal or barrier panel 1 can be reinforced as shown in FIG. 11B if desired or reinforced using some other structure/shape. The end portion 45 of the engaging structure 42 has a leading sloped or inclined surface 46 that helps deflect the engaging structure 42 inward so that the catch portion 45 can slide by the peripheral edge 41 of opening 40. Once the catch portion 45 clears the edge 41 of opening 40 it can engage the inner peripheral edge 41 of opening 40 as shown. The peripheral edge 41 of opening 40 can be recessed as depicted to accommodate the length of the engaging structures 42.

FIG. 11C shows the position of the adhesive bead from FIG. 11A. As can be seen, the manner in which the engaging structure 42 pulls the water seal or barrier panel 3 towards the inboard surface of the door panel 6 causes pressure to be applied to the adhesive bead 3, thereby ensuring that a good seal is formed by the adhesive bead 3 which will contain moisture. It is to be understood that the amount of force created by the engaging structures 42, which at a minimum should be sufficient to hold the water seal or barrier panel 1 in place during assembly of a door assembly, is determined in part by the length of the engaging structures 42 and the amount the peripheral edge 41 of the opening 40 in a door panel 6 is recessed. Other determining factors include the number of engaging structures, the resilience of the material from which the engaging structures and water seal or barrier panel 1 are made, the configuration and arrangement of the engaging structures, etc.

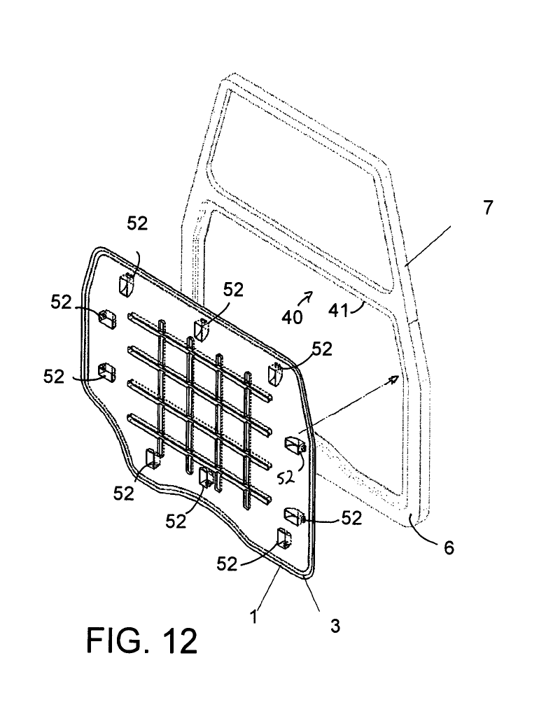

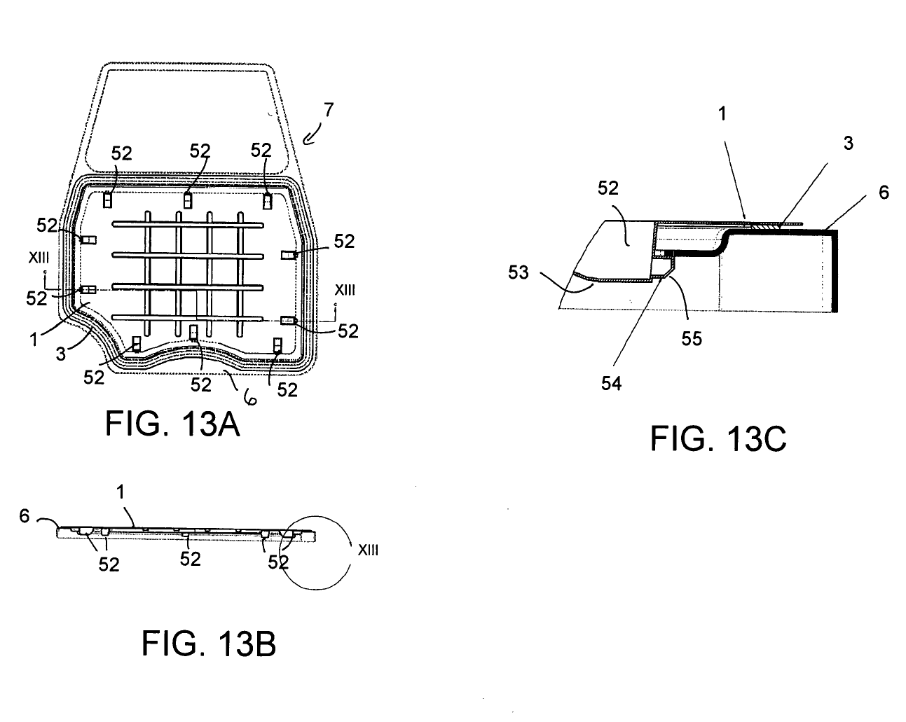

FIG. 12 is an exploded perspective view of a motor vehicle door assembly that includes a water seal or barrier panel according to another embodiment of the present invention. FIG. 13A is an elevational view of a door assembly showing a water seal or barrier panel according to one embodiment of the present invention in phantom. FIG. 13B is a sectional view of the door assembly of FIG. 13A taken along section lines XII-XII. FIG. 13C is an enlarged view of the encircled portion of the door assembly illustrated in FIG. 13B.

The embodiment of the invention depicted in FIGS. 12-13C is quite similar to the embodiment of the invention depicted in FIGS. 10-10C. The major difference is the shape and configuration of the engaging structures. In FIGS. 10-10C, the engaging structures 42 were solid structures. In FIGS. 12-13C the engaging structures 52 are hollow structures. As best seen in FIG. 13C the engaging structures 52 include a hollow base 53 that extends outward from the outboard surface of the water seal or barrier panel 1 and a hollow catch portion 54 that extends outward from an outer side portion of the hollow base portion 53. The leading edge 55 of the hollow catch portion 54 is slope or inclined inward so that the hollow catch portion 54 can slide by the peripheral edge 41 of opening 40 formed in a door panel 6. Once the hollow catch portion 54 clears the edge 41 of opening 40 it can engage the inner peripheral edge 41 of opening 40 as shown. The peripheral edge 41 of opening 40 can be recessed as depicted to accommodate the length of the engaging structures 52.

FIG. 13C shows the position of the adhesive bead 3 from FIG. 13A. As can be seen, the manner in which the engaging structure 52 pulls the water seal or barrier panel 1 towards the inboard surface of the door panel 6 causes pressure to be applied to the adhesive bead 3, thereby ensuring that a good seal is formed by the adhesive bead 3 which will contain moisture. It is to be understood that the amount of force created by the engaging structures 52, which at a minimum should be sufficient to hold the water seal or barrier panel 1 in place during assembly of a door assembly, is determined in part by the length of the engaging structures 52 and the amount the peripheral edge 41 of the opening 40 in a door panel 6 is recessed. Other determining factors include the number of engaging structures, the resilience of the material from which the engaging structures and water seal or barrier panel 1 are made, the configuration and arrangement of the engaging structures, etc.

FIGS. 10-13C depict limited examples of the shape and configuration of engaging structures that can be used according to the present invention. The illustrated engaging structures can be formed, e.g. molded, integrally with the water seal or barrier panels. Such integrally formed engaging structures can be solid, hollow or semi-hollow or can comprise portions that are solid, hollow and/or semi-hollow. For example, the catch portion 54 shown in FIG. 13C could be solid and the base portion 53 could be hollow. In alternative embodiments the engaging structures can be made separately from the water seal or barrier panels and attached or fixed thereto by adhesives, thermal or ultrasonic welding, mechanical fasteners, cooperating engaging structures, etc. In such alternative embodiments in which the engaging structures are made separately from the water seal or barrier panels and attached or fixed thereto, the engaging structures could be made from different materials than then water seal or barrier panels, including metals. In further embodiments at least some of the engaging structures could be configured to engage with through-holes provided in the inboard surface of door panels. In such an instance, such engaging structures could be similar in form to conventional push-in fasteners.

To assemble a door assembly using the water seal or barrier panels having the engaging structures thereon, one removes any release sheet that covers the adhesive bead and pushes the water seal or barrier panel against the inboard surface of a door panel so that each of the engaging structures engage an edge of the opening(s) formed in the inboard surface of the door panel. Next, an inner trim panel is attached to the door panel over the water seal or barrier panel using conventional fasteners, such as push-in fasteners which are receive in through-holes provided in the inboard surface of the door panel.

The c and door assemblies of the present invention can be used in conjunction with any type of vehicle door assembly, including front and rear door assemblies, sliding door assemblies, and rear door assemblies.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

1. A barrier liner for a vehicle door assembly having a door panel and an inner trim panel, said barrier liner comprising:
a sheet of substantially water-impermeable material that is substantially complimentarily shaped to the door panel; and
a sealing element that extends adjacent a peripheral portion of the sheet of substantially water-impermeable material and is integrally formed with the sheet of substantially water-impermeable material.

2. A barrier liner for a vehicle door assembly according to claim 1, wherein the sealing element and the sheet of substantially water-impermeable material are made from the same material.

3. A barrier liner for a vehicle door assembly according to claim 1, wherein the sealing element is made from a non-adhesive material.

4. A barrier liner for a vehicle door assembly according to claim 1, wherein the scaling element and the sheet of substantially water-impermeable material are molded together to be integral.

5. A barrier liner for a vehicle door assembly according to claim 1, wherein the sealing element is compressible.

6. A barrier liner for a vehicle door assembly according to claim 5, wherein the sealing element has a convex portion.

7. A barrier liner for a vehicle door assembly according to claim 6, wherein the sealing clement comprises a plurality of ribs.

8. A barrier liner for a vehicle door assembly according to claim 6, wherein the sealing element includes a substantially planar raised portion.

9. A barrier liner for a vehicle door assembly according to claim 2, wherein the sealing element and sheet of substantially water-impermeable material are made from an olefin foam.

10. The barrier liner of claim 1 in combination with a door assembly for a motor vehicle which includes a door panel against which the sealing element of the barrier liner forms a seal and an inner trim panel which extends over the barrier liner.

11. A barrier liner for a vehicle door assembly which comprises:
a sheet of substantially water-impermeable material that is substantially complimentarily shaped to the door panel having an inboard surface and an outboard surface; and
a plurality of engaging structures that extend outward from the outboard surface of the sheet of substantially water-impermeable material and which are configured to engage a peripheral edge of an opening formed in an inboard surface of a door panel.

12. The barrier liner for a vehicle door assembly according to claim 11 further comprising a bead of adhesive that extends along at least a portion of a periphery of the barrier liner on the outboard surface of the barrier liner.

13. The barrier liner for a vehicle door assembly according to claim 11, wherein the plurality of engaging structures are integrally formed with the sheet of substantially water-impermeable material.

14. The barrier liner for a vehicle door assembly according to claim 11, wherein at least a portion of the engaging structures are hollow.

15. The barrier liner for a vehicle door assembly according to claim 11, wherein the engaging structures comprise non-hollow portions.

16. The barrier liner for a vehicle door assembly according to claim 11, wherein the engaging structures and the sheet of substantially water-impermeable material are made form the same material.

17. The barrier liner of claim 11 in combination with a door assembly for a motor vehicle which includes a door panel against which the sealing element of the barrier liner forms a seal and an inner trim panel which extends over the barrier liner.

18. A method of assembling a door assembly which comprises:
providing a door panel having at least one opening formed in an inboard surface thereof;
providing an inner trim panel;
providing a barrier liner having a plurality of engaging structures that extend outward from an outboard surface of the barrier liner;
attaching the barrier liner to the inboard surface of the door panel by engaging the engaging structures of the barrier liner with a peripheral edge of the at least one opening formed in the inboard surface of the door panel; and
attaching the inner trim panel to the door panel over the barrier liner.

19. The method of assembling a door assembly according to claim 18, which further comprises proving a bead of adhesive that extends along at least a portion of a periphery of the barrier liner on the outboard surface of the barrier liner.

20. method of assembling a door assembly according to claim 19, wherein the bead of adhesive is pressed between the barrier liner and the door panel by a force created by the engagement of the engaging structures with the door panel.
